(19) United States
(12) Patent Application Publication
(10) Pub. No.: US 2020/0263764 A1
(43) Pub. Date: Aug. 20, 2020

(54) COAXIAL ORBITLESS DRIVE

(71) Applicant: Orbitless Drives Inc., Vancouver (CA)

(72) Inventor: Leo J. Stocco, Vancouver (CA)

(21) Appl. No.: 16/349,564

(22) PCT Filed: Nov. 29, 2017
(86) PCT No.: PCT/CA2017/051439

§ 371 Date: May 13, 2019

Related U.S. Application Data
(60) Provisional application No. 62/433,712, filed on Dec. 13, 2016.

(51) Int. Cl. F16H 1/28; F16H 7/02; F16H 57/08

(52) U.S. Cl. CPC F16H 1/28; F16H 57/082; F16H 7/02

(57) ABSTRACT

A coaxial orbitless drive is disclosed which has one or two offset carriers that are rotatably coupled to the case and a central carrier that is not. This minimizes cost, complexity and footprint and allows self-alignment of the central carrier with respect to an externally supported central member for minimum friction and optimum load sharing. The second offset carrier provides inertial balancing and reduces internal forces to improve torque capacity and power density. The present invention is well suited to applications that require in-line axes and high torque density as well as automotive multi-speed applications which use clutches and brakes to engage or dis-engage reduction and/or reversing stages.

### REFERENCE TO EARLIER FILED APPLICATIONS

This application makes reference to the Orbitless Gearbox disclosed in Patent Cooperation Treaty application PCT/CA2015/050423 and the Hybrid Orbitless Gearbox disclosed in Patent Cooperation Treaty application PCT/CA2015/050861.

### TECHNICAL FIELD

The disclosure herein relates to a drive comprising a plurality of gears or other engaging members. More particularly, it relates to an apparatus providing two members that rotate at different rates.

### BACKGROUND

An orbitless drive comprises a central pinion (sun) and a group of offset pinions (planets) which circulate on a pair of carriers. The central pinion may engage the offset pinions either directly or through a coupling, as disclosed in the prior art.

In practice, the central pinion and carrier may be attached to an externally supported rotating shaft. This external support may be sufficient to provide alignment, mechanical support and rotatably coupling, thereby eliminating the need for explicit support and rotatable coupling within the orbitless drive.

The exemplary embodiments disclosed herein depict an orbitless drive with no explicit mechanical support or rotatable coupling of the central pinion or carrier. This results in fewer parts, reduced cost, a smaller envelope, and allows the pinions to self-align for reduced friction, higher efficiency and longer life.

Certain exemplary embodiments disclosed herein include offset pinions with a second offset axis that is rotatably coupled with a second offset carrier. This result in lower internal forces and improved inertial balance when the case is permitted to rotate.

### SUMMARY

Certain exemplary embodiments comprise a reference member (79), a central carrier (9), a first offset carrier (19) and two or more offset members (39), each defining a central axis (70,0,10,30), wherein the reference member (79) and all offset members (39) each comprise a first offset axis (71,31) which is substantially parallel to, and spaced a first offset distance (91) apart from the corresponding central axis (70,30), the central carrier (9) and first offset carrier (19) each comprise a plurality of first radial axes (1,11) which are all substantially parallel to, spaced a first radial distance (93) apart from, and arranged circumferentially around the corresponding central axis (0,10), each offset member (39) central axis (30) and a different central carrier (9) first radial axis (1) are rotatably coupled (80), each offset member (39) first offset axis (31) and a different first offset carrier (19) first radial axis (11) are rotatably coupled (81), and the first offset carrier (19) central axis (10) and reference member (79) first offset axis (71) are rotatably coupled (83).

Certain exemplary embodiments further comprise a second offset carrier (29) defining a central axis (20) and wherein, the reference member (79) and all offset members (39) each further comprise a second offset axis (72,32) which is substantially parallel to, and spaced a second offset distance (92) apart from the corresponding central axis (70,30), the second offset carrier (29) comprises a plurality of first radial axes (21) which are all substantially parallel to, spaced a first radial distance (93) apart from, and arranged circumferentially around the central axis (20), each offset member (39) second offset axis (32) and a different first radial axis (21) are rotatably coupled (82), and the central axis (20) and reference member (79) second offset axis (72) are rotatably coupled (84).

Certain exemplary embodiments further comprise a first central member (41) which simultaneously engages (89) all offset members (39).

Certain exemplary embodiments further comprise a second central member (42) and one or more coupling members (59) wherein each coupling member (59) simultaneously engages (88,87) one or more offset members (39) and the second central member (42).

In certain exemplary embodiments, the central carrier (9) further comprises a number of second radial axes (2) equal to the number of coupling members (59), all second radial axes (2) are substantially parallel to, spaced a second radial distance (94) apart from, and arranged circumferentially around the central axis (0), and each coupling member (59) defines a central axis (50) which is rotatably coupled (85) with a different second radial axis (2).

### BRIEF DESCRIPTION OF DRAWINGS

FIG. 1 is a schematic side and front view in accordance with a first exemplary embodiment depicting the present invention.

FIG. 2 is a schematic side and front view in accordance with the first exemplary embodiment further comprising a second offset carrier (29).

FIG. 3 is a schematic side and front view in accordance with the first exemplary embodiment further comprising a first central member (41).

FIG. 4 is a schematic side and front and front view in accordance with the first exemplary embodiment further comprising a second offset carrier (29) and a first central member (41).

FIG. 5 is a schematic side and front view in accordance with the first exemplary embodiment further comprising a plurality of flexible coupling members (59) and a second central member (42).

FIG. 6 is a schematic side and front view in accordance with the first exemplary embodiment further comprising a second offset carrier (29), a plurality of flexible coupling members (59) and a second central member (42).

FIG. 7 is a schematic side and front view in accordance with the first exemplary embodiment further comprising a plurality of coupling members (59) and a second central member (42).

FIG. 8 is a schematic side and front view in accordance with the first exemplary embodiment further comprising a second offset carrier (29), a plurality of coupling members (59) and a second central member (42).

FIG. 9 is a schematic side and front view in accordance with the first exemplary embodiment further comprising a plurality of coupling members (59), a first central member (41) and a second central member (42).

FIG. 10 is a schematic side and front view in accordance with the first exemplary embodiment further comprising a second offset carrier (29), a plurality of coupling members (59), a first central member (41) and a second central member (42).

FIG. 11 is a perspective view of two exemplary offset member (39).

FIG. 12 is a schematic side view in accordance with a first exemplary practical implementation of the present invention.

FIG. 13 is a schematic side view in accordance with a second exemplary practical implementation of the present invention.

### REFERENCE NUMERALS

0—central axis
1—first radial axis
2—second radial axis
9—central carrier
10—central axis
11—first radial axis
19—first offset carrier
20—central axis
21—first radial axis
29—second offset carrier
30—central axis
31—first offset axis
32—second offset axis
33—shaft
34—shaft
35—shaft
36—bore
37—bore
39—offset member
41—first central member
42—second central member
50—central axis
59—coupling member
70—central axis
71—first offset axis
72—second offset axis
79—reference member
80—coupling
81—coupling
82—coupling
83—coupling
84—coupling
85—coupling
87—engagement
88—engagement
89—engagement
91—first offset distance
92—second offset distance
93—first radial distance
94—second radial distance
100—orbitless drive
101—motor
102—planetary drive
110—coupling
111—clutch
112—brake
113—drive-shaft
114—drive-shaft
115—ground

### Definitions

A gear, sprocket, pulley, friction or magnetic coupling, or any other type of member that engages and transmits power to a mate is defined as an engaging member.

An engaging member that engages on its exterior surface is defined as a pinion.

An engaging member that engages on its interior surface is defined as a ring.

A cable drive comprising two counter-acting, pre-loaded cables that are fixedly attached to two pulleys, is defined as a capstan cable coupling.

A chain, belt, cable, or any other means that changes shape while engaging two or more engaging members is defined as a flexible coupling.

A flexible coupling that simultaneously engages three or more engaging members is defined as a serpentine coupling.

An apparatus that scales the relative speed and torque of two rotating members is defined as a drive, which may or may not comprise any gears.

A drive that reduces velocity and amplifies torque is defined as a reduction drive.

A drive that amplifies velocity and reduces torque is defined as an overdrive drive.

A drive that may function as either a reduction or an overdrive drive is defined as back-drivable.

A drive that may function as a reduction drive but not as an overdrive is defined as self-locking.

### DESCRIPTION OF EMBODIMENTS

Wherever possible, the same reference numerals are used throughout the accompanying drawings and descriptions to refer to the same or similar parts.

Components such as bearings, retainers and fasteners that do not substantially contribute to the understanding of the invention are neglected for the sake of simplicity.

Whenever more than one reference member [79] is depicted, it is understood that they all correspond to a common integral reference member [79] with explicit connecting members omitted for the sake of simplicity.

Whenever spur gears are depicted in the accompanying drawings, it is understood that many other engaging means would suffice, such as conical, radial, offset, spiral, helical, double helical, herring-bone, or roller tooth gears, friction or magnetic couplings, chains and sprockets, or capstan cable couplings. It is also understood that associated gears may comprise any face width, tooth profile, pressure angle, or module and may be made from metal, plastic, or any other appropriate material.

Whenever a central member (41,42) is depicted as a pinion in the accompanying drawings, it is understood that it may often be replaced by a ring.

Whenever a coupling member (59) is depicted as a pinion in the accompanying drawings, it is understood that it may be often be replaced by a flexible coupling member and that a plurality of flexible coupling members may often be replaced by a serpentine coupling member.

Although three offset members (39) are depicted in the accompanying drawings, it is understood that any number may be included, as long as they do not mechanically interfere.

Although single-stage drives are depicted in the accompanying drawings, it is understood that multiple drives may be connected in series or in parallel and that the present invention may be combined with any other type of drive to obtain a desired speed ratio or other characteristic.

Although each offset member (39) is depicted in the accompanying drawings as comprising a single central rotatable coupling (80), it is understood that a second central rotatable coupling (80) could be added to the opposite side for symmetry.

Although all offset members (39) are depicted in the accompanying drawings as being substantially equivalent, it is understood that neighboring offset members (39) may comprise gear teeth that are out of phase with the first and second offset axes (31,32) to improve assemble-ability.

Although all coupling members (59) are depicted in the accompanying drawings as each engaging a single offset members (39) it is understood that a stiff, or serpentine coupling member (59) may simultaneously engage a plurality of offset members (39).

Although all first and second radial axes (1,2,11,21) are depicted in the accompanying drawings as being circumferentially equally spaced around the corresponding central axis (0,10,20), it is understood that they may be unequally spaced, although vibration may result.

It is understood that the male and female components of a rotatable coupling may often be interchanged.

It is understood that a back-drivable drive may provide either reduction or overdrive gearing by interchanging the roles of its high-speed and low-speed members. In fact, the roles of the reference, high-speed member and low-speed member may all be interchanged to obtain a desired reduction or overdrive ratio, or to cause the associated members to rotate in the same or opposite directions. Similarly, if any one is used as an input member and the remaining two are used as output members, a differential mechanism is obtained. Reduction, overdrive, differential, and reverse drives are all contemplated.

It is understood that any one of the reference member (79), any central member (41,42), any offset member (39), or any carrier (9,19,29) may act as a reference, input or output member.

A representative sample of embodiments is included in the accompanying drawings for exemplary purposes only. A great number of additional ring and pinion combinations and kinematic arrangements are also contemplated. The scope of the present invention is not limited to the embodiments included but spans all possible combinations anticipated by the specification and claims.

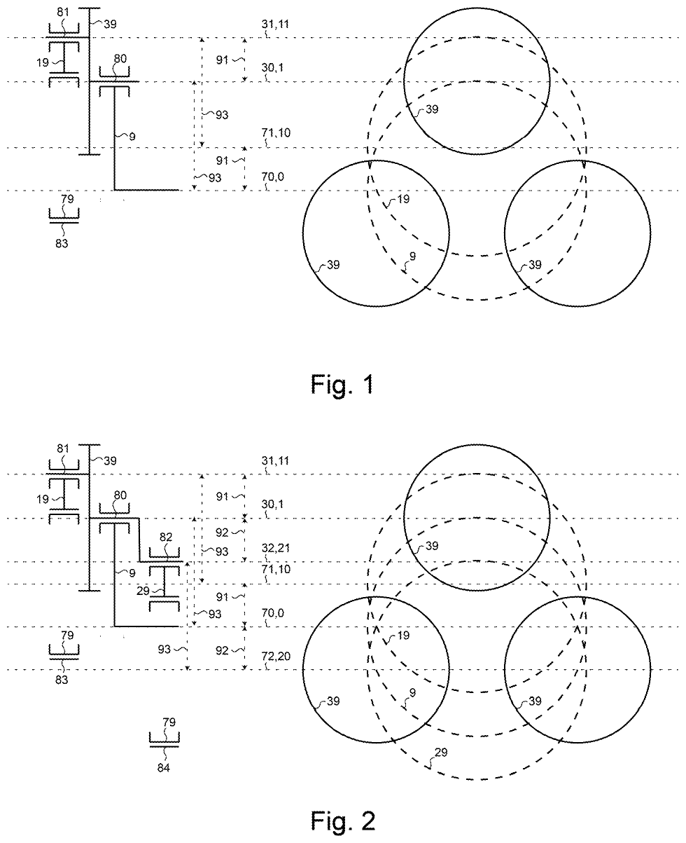

FIG. 1 illustrates a first exemplary embodiment of the present invention.

The first exemplary embodiment comprises a reference member (79), a central carrier (9), a first offset carrier (19) and two or more offset members (39).

The reference member (79) comprises a central axis (70) and a first offset axis (71).

The first offset axis (71) is substantially parallel to, and spaced a first offset distance (91) apart from the central axis (70).

Each offset member (39) comprises a central axis (30) and a first offset axis (31).

Each first offset axis (31) is substantially parallel to, and spaced the first offset distance (91) apart from the corresponding central axis (30).

The central carrier (9) comprises a central axis (0) and a number of first radial axes (1) equal to the number of offset members (39).

All first radial axes (1) are substantially parallel to, spaced a first radial distance (93) apart from, and arranged circumferentially around the central axis (0).

The first offset carrier (19) comprises a central axis (10) and a number of first radial axes (11) equal to the number of offset members (39).

All first radial axes (11) are substantially parallel to, spaced the first radial distance (93) apart from, and arranged circumferentially around the central axis (10).

Each central axis (30) is substantially co-axial, and rotatably coupled (80) with a different first radial axis (1).

Each first offset axis (31) is substantially co-axial, and rotatably coupled (81) with a different first radial axis (11).

The central axis (10) is substantially co-axial, and rotatably coupled (83) with the first offset axis (71).

FIG. 2 illustrates a second exemplary embodiment of the present invention which comprises the features of the first exemplary embodiment and further comprises a second offset carrier (29).

The reference member (79) further comprises a second offset axis (72) which is substantially parallel to, and spaced a second offset distance (92) apart from the central axis (70).

Each offset member (39) further comprises a second offset axis (32) which is substantially parallel to, and spaced the second offset distance (92) apart from the corresponding central axis (30).

The second offset carrier (29) comprises a central axis (20) and a number of first radial axes (21) equal to the number of offset members (39).

All first radial axes (21) are substantially parallel to, spaced the first radial distance (93) apart from, and arranged circumferentially around the central axis (20).

Each second offset axis (32) is substantially co-axial, and rotatably coupled (82) with a different first radial axis (21).

The central axis (20) is substantially co-axial, and rotatably coupled (84) with the second offset axis (72).

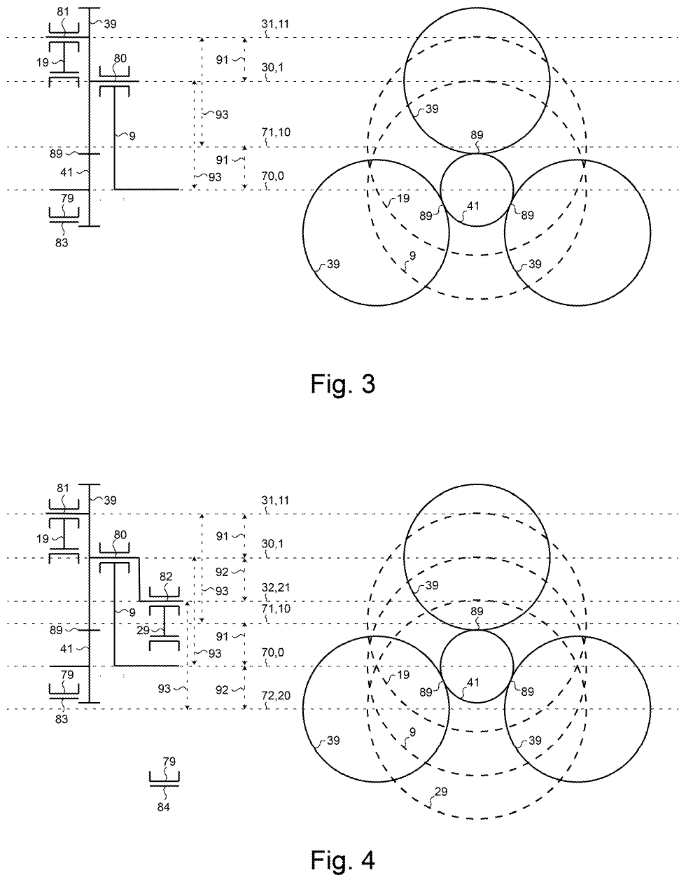

FIG. 3 illustrates a third exemplary embodiment of the present invention which comprises the features of the first exemplary embodiment and further comprises a first central member (41) which simultaneously engages (89) all offset members (39).

FIG. 4 illustrates a fourth exemplary embodiment of the present invention which combines the unique features of the first, second and third exemplary embodiments.

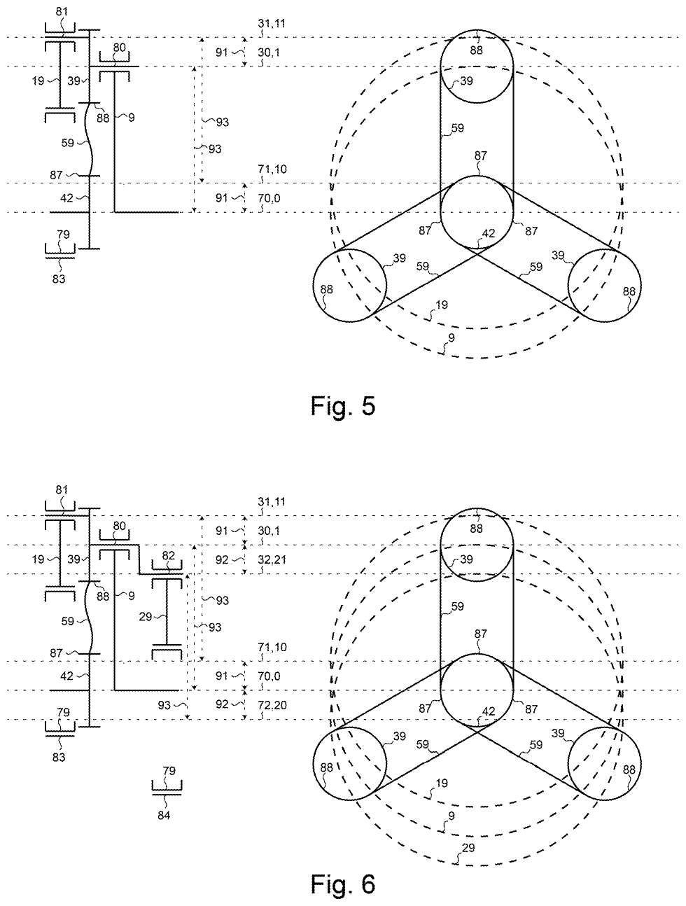

FIG. 5 illustrates a fifth exemplary embodiment of the present invention which combines the features of the first exemplary embodiment and further comprises a second central member (42) and a number of flexible coupling members (59) equal to the number of offset members (39).

The second central member (42) is substantially co-axial with the central axis (70) and simultaneously engages (87) all flexible coupling members (59) which each engage (88) a different offset member (39).

FIG. 6 illustrates a sixth exemplary embodiment of the present invention which combines the unique features of the first, second and fifth exemplary embodiments.

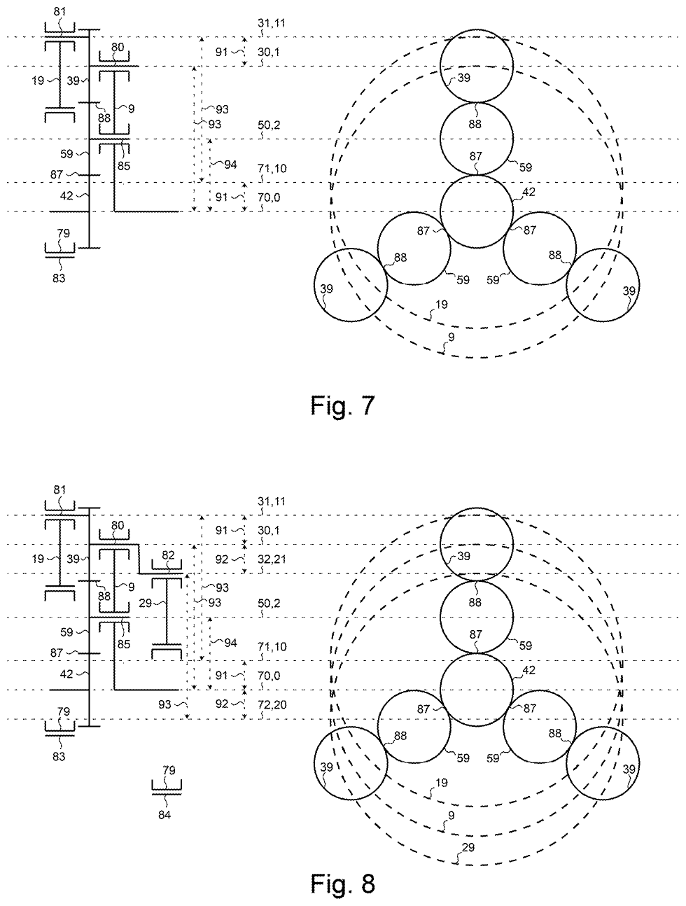

FIG. 7 illustrates a seventh exemplary embodiment of the present invention which combines the features of the first exemplary embodiment and further comprises a second central member (42) and a number of coupling members (59) equal to the number of offset members (39).

The second central member (42) is substantially co-axial with the central axis (70) and simultaneously engages (87) all coupling members (59) which each engage (88) a different offset member (39).

The central carrier (9) further comprises a number of second radial axes (2) equal to the number of coupling members (59).

All second radial axes (2) are substantially parallel to, spaced a second radial distance (94) apart from, and arranged circumferentially around the central axis (0).

Each coupling member (59) further comprises a central axis (50) which is substantially co-axial, and rotatably coupled (85) with a different second radial axis (2).

FIG. 8 illustrates an eighth exemplary embodiment of the present invention which combines the unique features of the first, second and seventh exemplary embodiments.

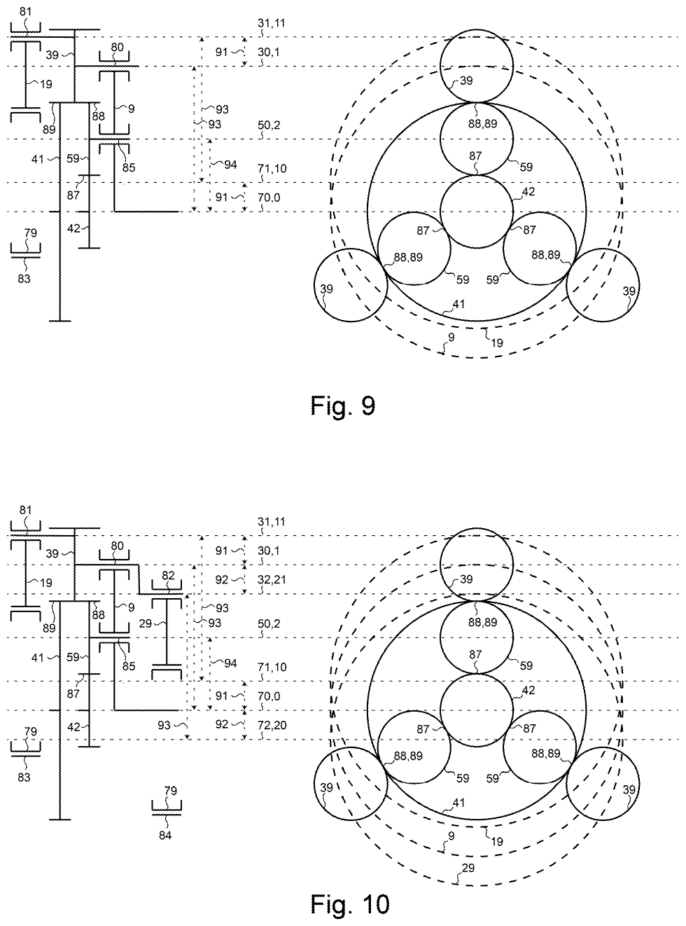

FIG. 9 illustrates a ninth exemplary embodiment of the present invention which combines the unique features of the first, third and seventh exemplary embodiments.

FIG. 10 illustrates a tenth exemplary embodiment of the present invention which combines the unique features of the first, second, third and seventh exemplary embodiments.

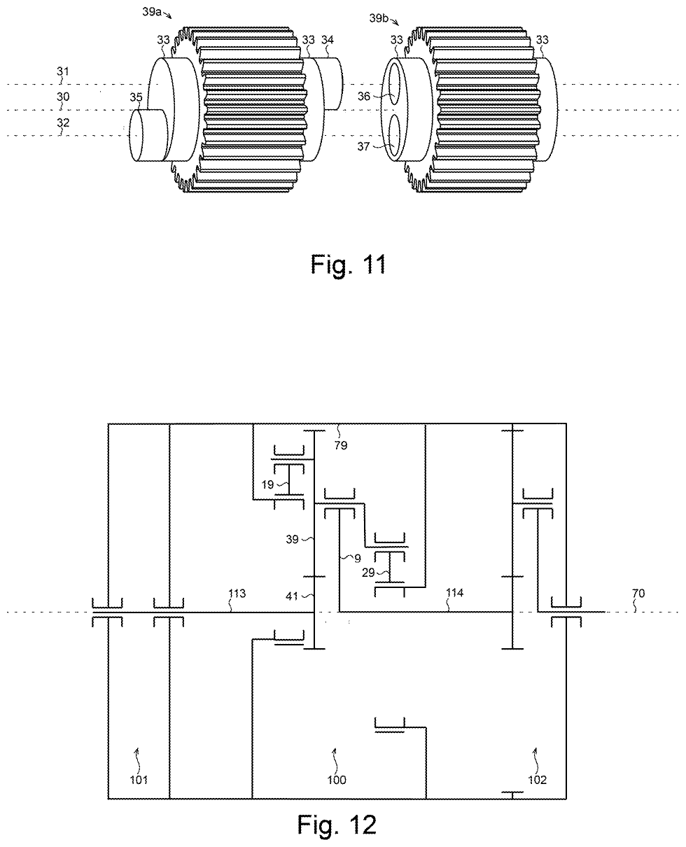

FIG. 11 depicts two exemplary offset members (39a,39b) that may be included in the second, fourth, eighth, or tenth exemplary embodiment of the present invention.

Each offset member (39a,39b) comprises a symmetric central shaft (33) that is co-axial with the central axis (30).

One offset member (39a) illustrates a first offset shaft (34) that is co-axial with the first offset axis (31), and a second offset shaft (35) that is co-axial with the second offset axis (32).

The other offset member (39b) illustrates a first offset bore (36) that is co-axial with the first offset axis (31), and a second offset bore (37) that is co-axial with the second offset axis (32).

FIG. 12 illustrates a first exemplary practical application of an orbitless drive (100) that corresponds to the fourth exemplary embodiment of the present invention.

The first exemplary practical application comprises a motor (101), an orbitless drive (100) and a planetary drive (102).

The central axes (70) of the motor (101), oribitless drive (100), and planetary drive (102) are all common.

The reference members (79) of the motor (101), oribitless drive (100), and planetary drive (102) are all integral.

The output shaft (113) of the motor (101) and the first central member (41) of the orbitless drive (100) are co-axial and integral.

The input shaft (114) of the planetary drive (102) and the central carrier (9) of the orbitless drive (100) are co-axial and integral.

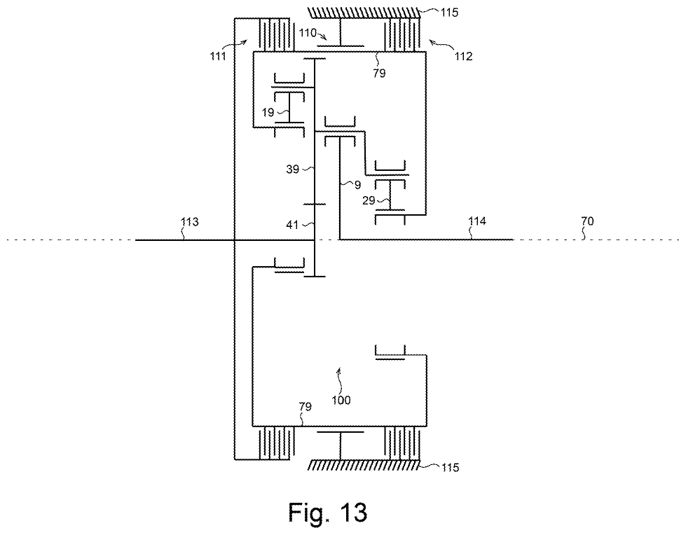

FIG. 13 illustrates a second exemplary practical application of an orbitless drive (100) that corresponds to the fourth exemplary embodiment of the present invention.

The second exemplary practical application comprises an orbitless drive (100), an activate-able clutch (111), an activate-able brake (112), a high-speed drive-shaft (113), and a low-speed drive-shaft (114).

The reference member (79) and ground (115) are rotatably coupled (110).

The reference member (79) and first central member (41) are fixably engaged when the clutch (111) is activated.

The reference member (79) and ground (115) are fixably engaged when the brake (112) is activated.

The high-speed drive-shaft (113) and first central member (41) are co-axial and integral.

The low-speed drive-shaft (114) and central carrier (9) are co-axial and integral.

### EXAMPLES

A first example considers the first exemplary embodiment illustrated in FIG. 1.

Locating the central axes (0,70) such that they are co-axial, and rotating the central carrier (9) about its central axis (0) causes each offset member (39) to circulate around the central axis (70) without rotating about its own corresponding central axis (30).

A second example considers the second exemplary embodiment illustrated in FIG. 2.

The central axes (0,70) are substantially co-axial due to mechanical constraints imposed by the first and second offset carriers (19,29).

Rotating the central carrier (9) about its central axis (0) causes each offset member (39) to circulate around the central axis (70) without rotating about its own corresponding central axis (30).

A third example considers the third exemplary embodiment illustrated in FIG. 3.

Locating the central axes (0,70) such that they are co-axial, and rotating the central carrier (9) about its central axis (0) causes each offset member (39) to circulate around the central axis (70) without rotating about its own corresponding central axis (30) and to engage (89) the first central member (41), causing it to rotate at a different rate than the central carrier (9).

A fourth example considers the fourth exemplary embodiment illustrated in FIG. 4.

The central axes (0,70) are substantially co-axial due to mechanical constraints imposed by the first and second offset carriers (19,29).

The first central member (41) and central axis (70) are substantially co-axial due to mechanical constraints imposed by the engagements (89).

Rotating the central carrier (9) about its central axis (0) causes each offset member (39) to circulate around the central axis (70) without rotating about its own corresponding central axis (30) and to engage (89) the first central member (41), causing it to rotate at a different rate than the central carrier (9).

A fifth example considers the fifth exemplary embodiment illustrated in FIG. 5.

Locating the central axes (0,70) and second central member (42) such that they are all co-axial, and rotating the central carrier (9) about its central axis (0) causes each offset member (39) to circulate around the central axis (70) without rotating about its own corresponding central axis (30), and to engage (88) a flexible coupling member (59) which engages (87) the second central member (42), causing it to rotate at a different rate than the central carrier (9).

A sixth example considers the sixth exemplary embodiment illustrated in FIG. 6.

The central axes (0,70) are substantially co-axial due to mechanical constraints imposed by the first and second offset carriers (19,29).

Locating the central axis (70) and second central member (42) such that they are co-axial, and rotating the central carrier (9) about its central axis (0) causes each offset member (39) to circulate around the central axis (70) without rotating about its own corresponding central axis (30), and to engage (88) a flexible coupling member (59) which engages (87) the second central member (42), causing it to rotate at a different rate than the central carrier (9).

A seventh example considers the seventh exemplary embodiment illustrated in FIG. 7.

Locating the central axes (0,70) and second central member (42) such that they are all co-axial, and rotating the central carrier (9) about its central axis (0) causes each offset member (39) to circulate around the central axis (70) without rotating about its own corresponding central axis (30), and to engage (88) a coupling member (59) which engages (87) the second central member (42), causing it to rotate at a different rate than the central carrier (9).

An eighth example considers the eighth exemplary embodiment illustrated in FIG. 8.

The central axes (0,70) are substantially co-axial due to mechanical constraints imposed by the first and second offset carriers (19,29).

The second central member (42) and central axis (70) are substantially co-axial due to mechanical constraints imposed by the engagements (87).

Rotating the central carrier (9) about its central axis (0) causes each offset member (39) to circulate around the central axis (70) without rotating about its own corresponding central axis (30), and to engage (88) a coupling member (59) which engages (87) the second central member (42), causing it to rotate at a different rate than the central carrier (9).

A ninth example considers the ninth exemplary embodiment illustrated in FIG. 9.

Locating the central axes (0,70), first central member (41), and second central member (42) such that they are all co-axial, and rotating the central carrier (9) about its central axis (0) causes each offset member (39) to circulate around the central axis (70) without rotating about its own corresponding central axis (30), and to engage (89) the first central member (41), causing it to rotate at a different rate than the central carrier (9).

Each offset member (39) simultaneously engages (88) a coupling member (59) which engages (87) the second central member (42), causing it to rotate at a different rate than the central carrier (9).

A tenth example considers the tenth exemplary embodiment illustrated in FIG. 10.

The central axes (0,70) are substantially co-axial due to mechanical constraints imposed by the first and second offset carriers (19,29).

The first central member (41) and central axis (70) are substantially co-axial due to mechanical constraints imposed by the engagements (89).

The second central member (42) and central axis (70) are substantially co-axial due to mechanical constraints imposed by the engagements (87).

Rotating the central carrier (9) about its central axis (0) causes each offset member (39) to circulate around the central axis (70) without rotating about its own corresponding central axis (30), and to engage (89) the first central member (41), causing it to rotate at a different rate than the central carrier (9).

Each offset member (39) simultaneously engages (88) a coupling member (59) which engages (87) the second central member (42), causing it to rotate at a different rate than the central carrier (9).

An eleventh example considers the offset members (39a,39b) illustrated in FIG. 11.

Both offset members (39a,39b) comprise a symmetric pair of central shafts (33) providing the male component of the rotatable coupling (80) on the central axis (30).

One offset member (39a) comprises offset shafts (34,35) providing the male components of the rotatable couplings (81,82) on the first and second offset axes (31,32).

The other offset member (39b) comprises offset bores (36,37) providing the female components of the rotatable couplings (81,82) on the first and second offset axes (31,32).

A twelfth example considers the actuated 2-stage drive illustrated in FIG. 12.

The drive-shaft (113) of the motor (101) provides co-axial alignment and rotatable coupling between the first central member (41) and the central axis (70) of the reference member (79).

The drive-shaft (114) of the planetary drive (102) provides co-axial alignment and rotatable coupling between the central axis (0) of the first central carrier (9) and the central axis (70) of the reference member (79).

A thirteenth example considers the 2-speed orbitless drive (100) illustrated in FIG. 13.

When clutch (111) is engaged and brake (112) is dis-engaged, the reference member (79), first central member (41), and central carrier (9) all rotate in unison, and the high-speed drive-shaft (113) and low-speed drive-shaft (114) rotate at a common rate.

When the first and second offset distances (91,92) are equal, the first and second offset carriers (19,29) counter-balance one another when the entire assembly rotates about the central axis (70).

When clutch (111) is dis-engaged and brake (112) is engaged, the orbitless drive (100) operates as described in the fourth example, and the high-speed drive-shaft (113) and low-speed drive-shaft (114) rotate at different rates.

### Advantages

The exemplary embodiments disclosed herein have a number of advantageous properties.

Certain exemplary embodiments require fewer bearings than a conventional orbitless drive.

Certain exemplary embodiments are less expensive to produce than a conventional orbitless drive.

Certain exemplary embodiments have a smaller envelope than a conventional orbitless drive.

Certain exemplary embodiments provide improved load sharing than a conventional orbitless drive.

Certain exemplary embodiments develop smaller internal forces than a conventional orbitless drive.

Certain exemplary embodiments have a higher torque capacity than a conventional orbitless drive.

Certain exemplary embodiments develop less vibration when the entire assembly is rotated than a conventional orbitless drive.

Other advantages are apparent from the disclosure herein.

1. An apparatus comprising a reference member (79), a central carrier (9), a first offset carrier (19) and two or more offset members (39), wherein:
the reference member (79) comprises a central axis (70) and a first offset axis (71);
the first offset axis (71) is substantially parallel to, and spaced a first offset distance (91) apart from the central axis (70);
each offset member (39) comprises a central axis (30) and a first offset axis (31);
each first offset axis (31) is substantially parallel to, and spaced the first offset distance (91) apart from the corresponding central axis (30);
the central carrier (9) comprises a central axis (0) and a number of first radial axes (1) equal to the number of offset members (39);
all first radial axes (1) are substantially parallel to, spaced a first radial distance (93) apart from, and arranged circumferentially around the central axis (0);
the first offset carrier (19) comprises a central axis (10) and a number of first radial axes (11) equal to the number of offset members (39);
all first radial axes (11) are substantially parallel to, spaced the first radial distance (93) apart from, and arranged circumferentially around the central axis (10);
each central axis (30) is substantially co-axial, and rotatably coupled (80) with a different first radial axis (1);
each first offset axis (31) is substantially co-axial, and rotatably coupled (81) with a different first radial axis (11);
and the central axis (10) is substantially co-axial, and rotatably coupled (83) with the first offset axis (71).

2. The apparatus of claim 1 further comprising a second offset carrier (29), and wherein:
the reference member (79) further comprises a second offset axis (72) which is substantially parallel to, and spaced a second offset distance (92) apart from the central axis (70);
each offset member (39) further comprises a second offset axis (32) which is substantially parallel to, and spaced the second offset distance (92) apart from the corresponding central axis (30);
the second offset carrier (29) comprises a central axis (20) and a number of first radial axes (21) equal to the number of offset members (39);
all first radial axes (21) are substantially parallel to, spaced the first radial distance (93) apart from, and arranged circumferentially around the central axis (20);
each second offset axis (32) is substantially co-axial, and rotatably coupled (82) with a different first radial axis (21);
and the central axis (20) is substantially co-axial, and rotatably coupled (84) with the second offset axis (72).

3. The apparatus of claim 1 further comprising a first central member (41) which simultaneously engages (89) all offset members (39).

4. The apparatus of claim 1 further comprising a second central member (42) and one or more coupling members (59), and wherein:
each coupling member (59) simultaneously engages (88) one or more offset members (39);
and the second central member (42) simultaneously engages (87) all coupling members (59).

5. The apparatus of claim 4 wherein:
the central carrier (9) further comprises a number of second radial axes (2) equal to the number of coupling members (59);
all second radial axes (2) are substantially parallel to, spaced a second radial distance (94) apart from, and arranged circumferentially around the central axis (0);
each coupling member (59) further comprises a central axis (50) which is substantially co-axial, and rotatably coupled (85) with a different second radial axis (2).

6. An apparatus comprising:
a reference member (79), a central carrier (9), a first offset carrier (19) and two or more offset members (39), each defining a central axis (70,0,10,30), wherein;
the reference member (79) and all offset members (39) each comprise a first offset axis (71,31) which is substantially parallel to, and spaced a first offset distance (91) apart from the corresponding central axis (70,30);
the central carrier (9) and first offset carrier (19) each comprise a plurality of first radial axes (1,11) which are all substantially parallel to, spaced a first radial distance (93) apart from, and arranged circumferentially around the corresponding central axis (0,10);
each offset member (39) central axis (30) and a different central carrier (9) first radial axis (1) are rotatably coupled (80);
each offset member (39) first offset axis (31) and a different first offset carrier (19) first radial axis (11) are rotatably coupled (81);
and the first offset carrier (19) central axis (10) and reference member (79) first offset axis (71) are rotatably coupled (83).

7. The apparatus of claim 6 further comprising a second offset carrier (29) defining a central axis (20) and wherein:
the reference member (79) and all offset members (39) each further comprise a second offset axis (72,32) which is substantially parallel to, and spaced a second offset distance (92) apart from the corresponding central axis (70,30);
the second offset carrier (29) comprises a plurality of first radial axes (21) which are all substantially parallel to, spaced a first radial distance (93) apart from, and arranged circumferentially around the central axis (20);
each offset member (39) second offset axis (32) and a different first radial axis (21) are rotatably coupled (82);
and the central axis (20) and reference member (79) second offset axis (72) are rotatably coupled (84).

8. The apparatus of claim 6 further comprising a first central member (41) which simultaneously engages (89) all offset members (39).

9. The apparatus of claim 6 further comprising a second central member (42) and one or more coupling members (59) wherein each coupling member (59) simultaneously engages (88,87) one or more offset members (39) and the second central member (42).

10. The apparatus of claim 9 wherein:
the central carrier (9) further comprises a number of second radial axes (2) equal to the number of coupling members (59);
all second radial axes (2) are substantially parallel to, spaced a second radial distance (94) apart from, and arranged circumferentially around the central axis (0);
and each coupling member (59) defines a central axis (50) which is rotatably coupled (85) with a different second radial axis (2).

11. A method comprising:
providing a reference member (79), a central carrier (9), a first offset carrier (19) and two or more offset members (39);
providing the reference member (79) with a central axis (70) and a first offset axis (71) that is substantially parallel to, and spaced a first offset distance (91) apart from the central axis (70);
providing each offset member (39) with a central axis (30) and a first offset axis (31) that is substantially parallel to, and spaced the first offset distance (91) apart from the corresponding central axis (30);
providing the central carrier (9) with a central axis (0) and a number of first radial axes (1) equal to the number of offset members (39);
locating all first radial axes (1) such that they are substantially parallel to, spaced a first radial distance (93) apart from, and arranged circumferentially around the central axis (0);
providing the first offset carrier (19) with a central axis (10) and a number of first radial axes (11) equal to the number of offset members (39);
locating all first radial axes (11) such that they are substantially parallel to, spaced the first radial distance (93) apart from, and arranged circumferentially around the central axis (10);
rotatably coupling (80) each central axis (30) with a different first radial axis (1);
rotatably coupling (81) each first offset axis (31) with a different radial axis (11);
and rotatably coupling (83) the central axis (10) with the first offset axis (71).

12. The method of claim 11 further providing a second offset carrier (29);
providing the reference member (79) with a second offset axis (72) that is substantially parallel to, and spaced a second offset distance (92) apart from the central axis (70);
providing each offset member (39) with a second offset axis (32) that is substantially parallel to, and spaced the second offset distance (92) apart from the corresponding central axis (30);
providing the second offset carrier (29) with a central axis (20) and a number of first radial axes (21) equal to the number of offset members (39);
locating all first radial axes (21) such that they are substantially parallel to, spaced a first radial distance (93) apart from, and arranged circumferentially around the central axis (20);
rotatably coupling (82) each second offset axis (32) with a different radial axis (21);
and rotatably coupling (84) the central axis (20) with the second offset axis (72).

13. The method of claim 11 further providing a first central member (41) and simultaneously engaging (89) the first central member (41) with all offset members (39).

14. The method of claim 11 further providing a second central member (42) and one or more coupling members (59), and simultaneously engaging (88,87) each coupling member (59) with one or more offset members (39) and the second central member (42).

15. The method of claim 14;
providing the central carrier (9) with a number of second radial axes (2) equal to the number of coupling members (59);
locating all second radial axes (2) such that they are substantially parallel to, spaced a second radial distance (94) apart from, and arranged circumferentially around the central axis (0);
providing each coupling member (59) with a central axis (50) and rotatably coupling (85) it with a different second radial axis (2).
